(19) United States
(12) Patent Application Publication
(10) Pub. No.: US 2011/0290860 A1
(43) Pub. Date: Dec. 1, 2011

(54) Wire bonding apparatus and method thereof

(75) Inventors: Sijoong Yang, Suwon-si (KR); Bokgun Moon, Suwon-si (KR); Sanghun Park, Ansan-si (KR)

(73) Assignee: SAMSUNG ELECTRO-MECHANICS CO., LTD., Suwon (KR)

(21) Appl. No.: 13/067,010

(22) Filed: May 2, 2011

(30) Foreign Application Priority Data
May 25, 2010 (KR) 10-2010-0048649

(51) Int. Cl. B23K 31/12; B23K 37/04; B23K 31/02

(52) U.S. Cl. 228/102; 228/4.5

(57) ABSTRACT

The present invention provides a wire bonding apparatus including: a lead frame loading unit for loading a lead frame, on which a semiconductor chip is mounted, on a transfer rail; a heater block for heating the loaded lead frame; a wire bonding tool for wire-bonding the semiconductor chip and leads of the lead frame; a lead frame unloading unit for unloading the wire-bonded lead frame from the transfer rail; and a control unit for detecting a wire bonding failure when the wire bonding failure occurs in the lead frame and separating the heater block from the lead frame after a predetermined time has elapsed from the occurrence of the wire bonding failure, and a method thereof.

### CROSS-REFERENCE TO RELATED APPLICATIONS

Claim and incorporate by reference domestic priority application and foreign priority application as follows:

### CROSS REFERENCE TO RELATED APPLICATION

This application claims the benefit under 35 U.S.C. Section 119 of Korean Patent Application Serial No. 10-2010-048649, entitled filed May 25, 2010, which is hereby incorporated by reference in its entirety into this application.

### BACKGROUND OF THE INVENTION

1. Field of the Invention

The present invention relates to a wire bonding apparatus and a method thereof, and more particularly, to a wire bonding apparatus and a method thereof that are capable of minimizing the occurrence of failures in wire bonding.

2. Description of the Related Art

In a manufacturing process of a semiconductor package using a lead frame, a wire bonding process for electrically connecting a semiconductor chip and a lead frame by a metal wire is performed after a chip attaching process for mounting the semiconductor chip on the lead frame. For example, the wire bonding process is performed in such a way that the metal wire is bonded on a metal pad layer of the semiconductor chip by locally melting the metal pad layer of the semiconductor chip with ultrasonic waves.

In order to improve bondability in the wire bonding, as seen from the formula: F=4 μNfu, a coefficient of friction of a surface of a metal layer is very important along with a bonding pressure (N), an ultrasonic displacement (μ), and an ultrasonic frequency (f). For this, plasma cleaning is performed in the wire bonding process before providing raw materials to the process. It is possible to obtain high bondability by removing contaminants and an oxide layer on the surface of the metal layer through the plasma cleaning.

Further, in order to secure excellent wire bondability in the wire bonding, the wire bonding process is performed by using a metal wire in a state in which a lead frame and a semiconductor chip mounted thereon are heated by transferring heat of more than about 200° C. to a lower surface of the lead frame. For this, a wire bonding apparatus includes a separate heater block, and the heater block comes into contact with the lower surface of the lead frame to heat the lead frame.

However, in this case, even though the wire bonding process is stopped due to problems occurred during the wire bonding process or various other reasons, the lead frame is continuously heated by the heater block which is in contact with the lower surface thereof, on which the semiconductor is mounted. Accordingly, an oxide layer is formed on the surface of the lead frame again. The formed oxide layer deteriorates the excellent wire bondability between the metal wire and the lead frame and eventually causes an open failure or incomplete bonding of the semiconductor chip.

### SUMMARY OF THE INVENTION

The present invention has been invented in order to overcome the above-described problems and it is, therefore, an object of the present invention to provide a wire bonding apparatus capable of improving bondability of a lead frame by managing a heating time of the lead frame on which a semiconductor chip is mounted.

In accordance with one aspect of the present invention to achieve the object, there is provided a wire bonding apparatus including: a lead frame loading unit for loading a lead frame, on which a semiconductor chip is mounted, on a transfer rail; a heater block for heating the loaded lead frame; a wire bonding tool for wire-bonding the semiconductor chip and leads of the lead frame; a lead frame unloading unit for unloading the wire-bonded lead frame from the transfer rail; and a control unit for detecting a wire bonding failure when the wire bonding failure occurs in the lead frame and separating the heater block from the lead frame after a predetermined time has elapsed from the occurrence of the wire bonding failure.

At this time, the wire bonding apparatus may further include a gas supply unit for supplying a reducing gas to the lead frame, and the control unit may separate the heater block from the lead frame and spray the reducing gas to the lead frame after the predetermined time has elapsed from the occurrence of the wire bonding failure.

Meanwhile, the control unit may include an error detecting unit for detecting the wire bonding failure; a timer for calculating the elapsed time from when the wire bonding failure is detected by the error detecting unit; and an error processing unit for separating the heater block from the lead frame and spraying the reducing gas to the lead frame when the elapsed time calculated by the timer exceeds the predetermined time.

At this time, the control unit may further include a display unit for outputting a warning screen when the elapsed time calculated by the timer exceeds the predetermined time.

Meanwhile, in accordance with another aspect of the present invention to achieve the object, there is provided a wire bonding apparatus including: a lead frame loading unit for loading a lead frame, on which a semiconductor chip is mounted, on a transfer rail; a heater block for heating the loaded lead frame; a wire bonding tool for wire-bonding the semiconductor chip and leads of the lead frame; a lead frame unloading unit for unloading the wire-bonded lead frame from the transfer rail; and a control unit for detecting a wire bonding failure when the wire bonding failure occurs in the lead frame and cutting off power supplied to the heater block after a predetermined time has elapsed from the occurrence of the wire bonding failure.

At this time, the wire bonding apparatus may further include a gas supply unit for supplying a reducing gas to the lead frame, and the control unit may cut off the power supplied to the heater block and spray the reducing gas to the lead frame after the predetermined time has elapsed from the occurrence of the wire bonding failure.

Meanwhile, the control unit may include an error detecting unit for detecting the wire bonding failure; a timer for calculating the elapsed time from when the wire bonding error is detected by the error detecting unit; and an error processing unit for cutting off the power supplied to the heater block and spraying the reducing gas to the lead frame when the elapsed time calculated by the timer exceeds the predetermined time.

At this time, the control unit may further include a display unit for outputting a warning screen when the elapsed time calculated by the timer exceeds the predetermined time

Meanwhile, in accordance with still another aspect of the present invention to achieve the object, there is provided a wire bonding method including the steps of: loading a lead frame, on which a semiconductor chip is mounted, on a transfer rail, in a wire bonding apparatus; heating the loaded lead frame by using a heater block, in the wire bonding apparatus; wire-bonding the semiconductor chip and leads of the lead frame, in the wire bonding apparatus; detecting a wire bonding error in the wire bonding step, in the wire bonding apparatus; calculating an elapsed time from when the wire bonding error is detected, in the wire bonding apparatus; and separating the heater block from the lead frame when the elapsed time exceeds a predetermined time, in the wire bonding apparatus.

At this time, the wire bonding method may further include, after the step of calculating the elapsed time and before the step of separating the heater block from the lead frame, the step of displaying a warning screen, in the wire bonding apparatus.

Further, the step of separating the heater block from the lead frame may further include the step of spraying a reducing gas to the lead frame.

Meanwhile, in accordance with still another aspect of the present invention to achieve the object, there is provided a wire bonding method including the steps of: loading a lead frame, on which a semiconductor chip is mounted, on a transfer rail, in a wire bonding apparatus; heating the loaded lead frame by using a heater block, in the wire bonding apparatus; wire-bonding the semiconductor chip and leads of the lead frame, in the wire bonding apparatus; detecting a wire bonding error in the wire bonding step, in the wire bonding apparatus; calculating an elapsed time from the wire bonding error is detected, in the wire bonding apparatus; and cutting off power supplied to the heater block when the elapsed time exceeds a predetermined time, in the wire bonding apparatus.

At this time, the wire bonding method may further include, after the step of calculating the elapsed time and before the step of cutting off the power supplied to the heater block, the step of displaying a warning screen, in the wire bonding apparatus.

Further, the step of cutting off the power supplied to the heater block may further include the step of spraying a reducing gas to the lead frame.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a block diagram showing a wire bonding apparatus 100 in accordance with an embodiment of the present invention;

FIG. 2 is a block diagram showing detailed configuration of a control unit of the wire bonding apparatus 100 in accordance with an embodiment of the present invention;

FIG. 3 is a graph showing a change in wire pull value with the lapse of working time in a wire bonding process;

FIG. 4 is a graph showing an error rate with the lapse of working time in a wire bonding process;

FIG. 5 is a flow chart showing a wire bonding method 500 in a wire bonding apparatus 100 in accordance with an embodiment of the present invention; and

FIG. 6 is a flow chart showing a wire bonding method 600 in a wire bonding apparatus 100 in accordance with another embodiment of the present invention.

### DETAILED DESCRIPTION OF THE PREFERABLE EMBODIMENTS

Hereinafter, specific embodiments of the present invention will be described with reference to the accompanying drawings. However, the following embodiments are provided as examples but are not intended to limit the present invention thereto.

Descriptions of well-known components and processing techniques are omitted so as not to unnecessarily obscure the embodiments of the present invention. The following terms are defined in consideration of functions of the present invention and may be changed according to users or operator's intentions or customs. Thus, the terms shall be defined based on the contents described throughout the specification.

The technical spirit of the present invention should be defined by the appended claims, and the following embodiments are merely examples for efficiently describing the technical spirit of the present invention to those skilled in the art.

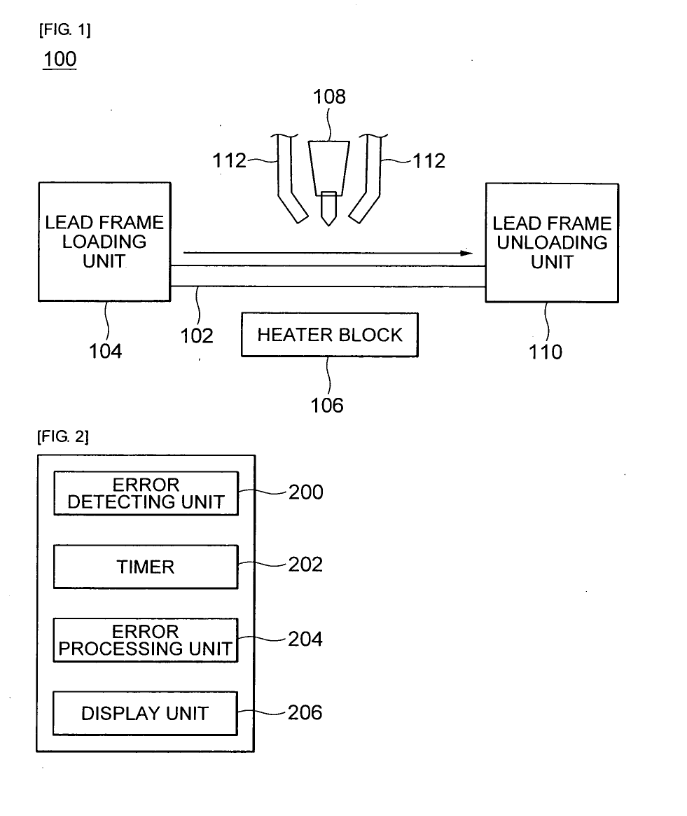

FIG. 1 is a block diagram showing a wire bonding apparatus 100 in accordance with an embodiment of the present invention.

A wire bonding apparatus 100 in accordance with an embodiment of the present invention may include a transfer rail 102, a lead frame loading unit 104, a heater block 106, a wire bonding tool 108, a lead frame unloading unit 110, and a control unit (not shown), and may further include a gas supply unit 112 according to need.

The transfer rail 102 is a rail that moves a lead frame in order to perform wire bonding on the lead frame on which a semiconductor chip is mounted, the lead frame loading unit 104 is a block that loads the lead frame, on which the semiconductor chip is mounted, on the transfer rail 102, and the lead frame unloading unit 110 is a block that unloads the wire-bonded lead frame from the transfer rail 102. As shown, the transfer rail 102 is positioned between the lead frame loading unit 104 and the lead frame unloading unit 106, and the lead frame on which the semiconductor chip is mounted is loaded on the transfer rail 102 by the lead frame loading unit 104 and unloaded by the lead frame unloading unit 110 after a wire bonding process. An arrow in the drawing indicates a moving direction of the lead frame.

The heater block 106 is positioned under the transfer rail 102 and heats the lead frame loaded on the transfer rail 102 by the lead frame loading unit 104. The heater block 106 is divided into a pre-heater and a main heater according to positions. The pre-heater preheats the lead frame before wire bonding, and the main heater heats the lead frame preheated by the pre-heater.

The wire bonding tool 108 performs wire bonding on the lead frame heated by the heater block 106. Specifically, the wire bonding tool 108 performs wire bonding by connecting an electrode pad of the semiconductor chip mounted on the lead frame and a front end of the lead frame through a metal wire.

The lead frame unloading unit 110 unloads the wire-bonded lead frame by the wire bonding tool 108 from the transfer rail 102.

The control unit performs a wire bonding process by controlling each component of the wire bonding apparatus 100 in accordance with an embodiment of the present invention, detects a wire bonding failure when the wire bonding failure occurs in the lead frame, blocks heat supplied to the lead frame after a predetermined time has elapsed from the occurrence of the wire bonding failure, and prevents formation of an oxide layer due to deterioration of the lead frame by supplying a reducing gas to the lead frame in case of need.

The gas supply unit 112 prevents the oxide layer from being formed on the lead frame by spraying the reducing gas to the lead frame according to control of the control unit.

FIG. 2 is a block diagram showing detailed configuration of the control unit of the wire bonding apparatus 100 in accordance with an embodiment of the present invention.

As shown, the control unit may include an error detecting unit 200, a timer 202, and an error processing unit 204, and may further include a display unit 206 according to need.

The error detecting unit 200 detects the wire bonding failure (error) in the wire bonding process performed by the wire bonding tool 108. For example, the detection of the wire bonding error may be performed by measuring a current after applying the micro current to the bonded wire. At this time, when the wire is not normally bonded to a chip pad, there is no current flow in the corresponding wire. This is called a chip pad open error. The above method of detecting a wire bonding failure by using a micro current is just one example, but it should be understood that the present invention is not limited to a specific method of detecting a wire bonding error.

The timer 202 calculates the elapsed time from when the wire bonding error is detected by the error detecting unit 200.

The error processing unit 204 prevents deterioration of the lead frame by blocking heat applied to the lead frame when the elapsed time calculated by the timer 202 exceeds the predetermined time.

In the present invention, one of the following two embodiments can be selected as a method of blocking heat applied to a lead frame.

First, it may be configured that the heater block 106 positioned at a lower end of the transfer rail 102 can be moved by control of the error processing unit 204. In this case, the error processing unit 204 blocks the heat applied to the lead frame by moving the heater block 106 so that the heater block 106 is separated from the lead frame when the elapsed time calculated by the timer 204 exceeds the predetermined time.

Second, it may be configured to cut off power supplied to the heater block 106 according to control of the error processing unit 204. In case of this embodiment, even though the power supplied to the heater block 106 is cut off, since it takes time to cool the heater block 106, a heat blocking effect may be slightly reduced in comparison with the previous embodiment, but this embodiment has an advantage in that it can be also applied to a wire bonding apparatus 100 with a fixed heater block 106 since there is no need of moving the heater block 106.

Further, the error processing unit 204 can prevent an oxide layer from being formed on the lead frame by spraying a reducing gas to the lead frame in case of need, simultaneously with preventing heat from being supplied to the lead frame by separating the heater block 106 or cutting off the power supplied to the heater block 106. For example, the reducing gas may be a N₂ gas or an H₂N₂ gas.

The display unit 206 may be configured to inform an operator that the wire bonding error occurs now by outputting a warning screen when the elapsed time calculated by the timer 202 exceeds the predetermined time.

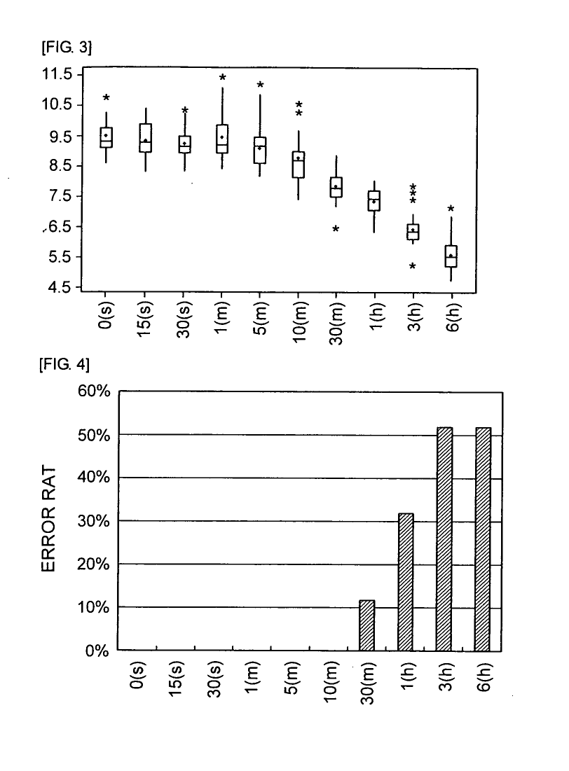

FIG. 3 is a graph showing a change in wire pull value with the lapse of working time in a wire bonding process, and FIG. 4 is a graph showing an open error rate with the lapse of working time in a wire bonding process. In the shown graph, the wire pull value represents a strength at which bonding is separated when the bonded wire is pulled.

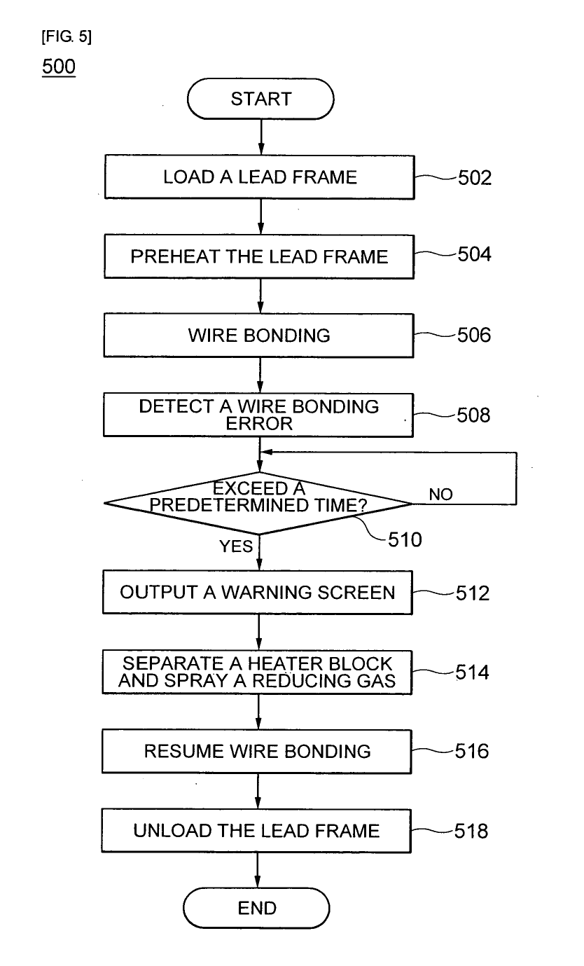

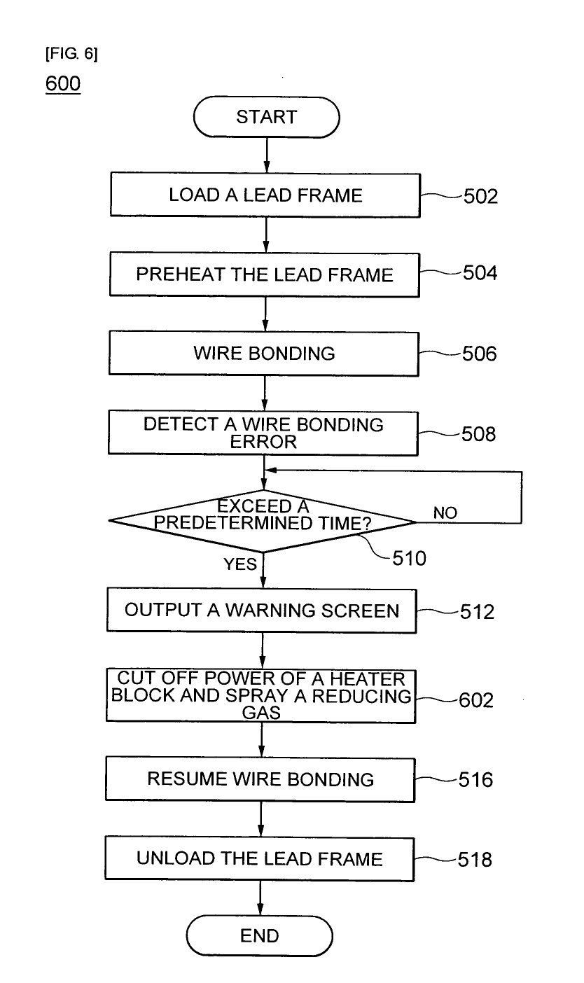

As shown, for a predetermined period of time after the wire bonding process is started, the wire pull value is maintained at a constant level and an open error also does not occur. However, as seen in FIG. 4, the wire pull value is rapidly decreased after about 10 minutes, as seen in FIG. 5, the open error does not occur up to 30 minutes, but the open error rate is rapidly increased in an interval between 30 minutes and 1 hour.

In the embodiment of the present invention, in consideration of this, the error processing unit 204 performs heater heat blocking and reducing gas injection after counting a predetermined time from the first time when the error occurs in order to prevent a rapid increase in the error rate during the wire bonding process and maintain the wire pull value at a constant level. The time counted by the timer 202 may be appropriately determined according to specific wire bonding environment and process conditions, and this is apparent to those skilled in the art to which the present invention pertains.

FIG. 5 is a flow chart showing a wire bonding method 500 in a wire bonding apparatus 100 in accordance with an embodiment of the present invention.

First, a lead frame on which a semiconductor chip is mounted is loaded on a transfer rail (502), the loaded lead frame is heated by using a heater block (504), and a wire bonding process is performed to wire-bond the heated semiconductor chip and leads of the lead frame (506).

After that, when a wire bonding error in the wire bonding process (506) is detected by an error detecting unit 200 (508), an elapsed time from when the wire bonding error is detected is calculated (510).

If the elapsed time exceeds a predetermined time, a display unit 206 outputs a warning screen for the wire bonding error (512), and an error processing unit 204 separates the heater block from the lead frame to prevent deterioration of the lead frame. Further, when the wire bonding apparatus 100 includes a gas supply unit 112, in addition to the separation of the heater block 106, a reducing gas is injected into the lead frame to prevent an oxide layer from being formed on the lead frame (514).

After that, when the lead frame is normalized, the wire bonding apparatus 100 resumes wire bonding (516), and when the wire bonding is completed, the lead frame is unloaded from the transfer rail 102 (518).

Meanwhile, even though it is shown in the drawing that the step of outputting the warning screen (512) and the step of separating the heater block and spraying the reducing gas (514) are sequentially performed, but it will be apparent that the above steps can be performed simultaneously or in reverse order according to embodiments in view of the object of the present invention.

FIG. 6 is a flow chart showing a wire bonding method 600 in a wire bonding apparatus 100 in accordance with another embodiment of the present invention.

As shown, most processes of the wire bonding method 600 in accordance with this embodiment are equal to those in FIG. 5, which are represented by the same reference numerals, but there is only a difference in that power supplied to a heater block 106 is cut off rather than separating the heater block 106 in the step 602. As described above, in case of this embodiment, the present invention has an advantage that it can be applied to a conventional wire bonding apparatus 100 having a fixed heater block 106.

Further, like FIG. 5, even though it is shown in FIG. 6 that the step of outputting a warning screen (512) and the step of cutting off the power supplied to the heater block and spraying a reducing gas (602) are sequentially performed, but it will be apparent that the above steps can be performed simultaneously or in reverse order according to embodiments in view of the object of the present invention.

According to the present invention, it is possible to improve bondability of a wire bonding process by blocking heat supplied to a lead frame and spraying a reducing gas after a predetermined time has elapsed from the occurrence of a wire bonding error to effectively prevent deterioration of the lead frame and formation of an oxide layer.

While the invention has been described in detail with reference to preferred embodiments thereof, it will be appreciated by those skilled in the art that changes may be made in these embodiments without departing from the scope of the invention.

Thus, the scope of the invention should be determined by the appended claims and their equivalents, rather than by the described embodiments.

What is claimed is:

1. A wire bonding apparatus comprising:
a lead frame loading unit for loading a lead frame, on which a semiconductor chip is mounted, on a transfer rail;
a heater block for heating the loaded lead frame;
a wire bonding tool for wire-bonding the semiconductor chip and leads of the lead frame;
a lead frame unloading unit for unloading the wire-bonded lead frame from the transfer rail; and
a control unit for detecting a wire bonding failure when the wire bonding failure occurs in the lead frame and separating the heater block from the lead frame after a predetermined time has elapsed from the occurrence of the wire bonding failure.

2. The wire bonding apparatus according to claim 1, further comprising a gas supply unit for supplying a reducing gas to the lead frame, and wherein the control unit separates the heater block from the lead frame and sprays the reducing gas to the lead frame after the predetermined time has elapsed from the occurrence of the wire bonding failure.

3. The wire bonding apparatus according to claim 2, wherein the control unit comprises:
an error detecting unit for detecting the wire bonding failure;
a timer for calculating the elapsed time from when the wire bonding failure is detected by the error detecting unit; and
an error processing unit for separating the heater block from the lead frame and spraying the reducing gas to the lead frame when the elapsed time calculated by the timer exceeds the predetermined time.

4. The wire bonding apparatus according to claim 3, wherein the control unit further comprises a display unit for displaying a warning screen when the elapsed time calculated by the timer exceeds the predetermined time.

5. A wire bonding apparatus comprising:
a lead frame loading unit for loading a lead frame, on which a semiconductor chip is mounted, on a transfer rail;
a heater block for heating the loaded lead frame;
a wire bonding tool for wire-bonding the semiconductor chip and leads of the lead frame;
a lead frame unloading unit for unloading the wire-bonded lead frame from the transfer rail; and
a control unit for detecting a wire bonding failure when the wire bonding failure occurs in the lead frame and cutting off power supplied to the heater block after a predetermined time has elapsed from the occurrence of the wire bonding error.

6. The wire bonding apparatus according to claim 5, further comprising a gas supply unit for supplying a reducing gas to the lead frame, and wherein the control unit cuts off the power-supplied to the heater block and sprays the reducing gas to the lead frame after the predetermined time has elapsed from the occurrence of the wire bonding failure.

7. The wire bonding apparatus according to claim 6, wherein the control unit comprises:
an error detecting unit for detecting the wire bonding failure;
a timer for calculating the elapsed time from when the wire bonding failure is detected by the error detecting unit; and
an error processing unit for cutting off the power supplied to the heater block and spraying the reducing gas to the lead frame when the elapsed time calculated by the timer exceeds the predetermined time.

8. The wire bonding apparatus according to claim 7, wherein the control unit further comprises a display unit for outing a warning screen when the elapsed time calculated by the timer exceeds the predetermined time.

9. A wire bonding method in a wire bonding apparatus comprising:
loading a lead frame, on which a semiconductor chip is mounted, on a transfer rail, in the wire bonding apparatus;
heating the loaded lead frame by using a heater block, in the wire bonding apparatus;
wire-bonding the semiconductor chip and leads of the lead frame, in the wire bonding apparatus;
detecting a wire bonding error in the wire bonding step, in the wire bonding apparatus;
calculating an elapsed time from the wire bonding error is detected, in the wire bonding apparatus; and
separating the heater block from the lead frame when the elapsed time exceeds a predetermined time, in the wire bonding apparatus.

10. The wire bonding method according to claim 9, further comprising, after calculating the elapsed time and before separating the heater block from the lead frame, displaying a warning screen, in the wire bonding apparatus.

11. The wire bonding method according to claim 9, wherein separating the heater block from the lead frame further comprises spraying a reducing gas to the lead frame.

12. A wire bonding method in a wire bonding apparatus comprising:
loading a lead frame, on which a semiconductor chip is mounted, on a transfer rail, in the wire bonding apparatus;
heating the loaded lead frame by using a heater block, in the wire bonding apparatus;
wire-bonding the semiconductor chip and leads of the lead frame, in the wire bonding apparatus;
detecting a wire bonding error in the wire bonding step, in the wire bonding apparatus;
calculating an elapsed time from the wire bonding error is detected, in the wire bonding apparatus; and
cutting off power supplied to the heater block when the elapsed time exceeds a predetermined time.

13. The wire bonding method according to claim 12, further comprising, after calculating the elapsed time and before cutting off the power supplied to the heater block, displaying a warning screen, in the wire bonding apparatus.

14. The wire bonding method according to claim 12, wherein cutting off the power supplied to the heater block further comprises spraying a reducing gas to the lead frame.
